(19) United States
(12) Patent Application Publication
(10) Pub. No.: US 2024/0428350 A1
(43) Pub. Date: Dec. 26, 2024

(54) SYSTEM AND METHODS FOR WATER TESTING COMPLIANCE

(71) Applicant: Tomea LLC, Doylestown, PA (US)

(72) Inventor: Aaron McGarvey, Doylestown, PA (US)

(21) Appl. No.: 18/750,889

(22) Filed: Jun. 21, 2024

Related U.S. Application Data
(60) Provisional application No. 63/509,309, filed on Jun. 21, 2023.

(51) Int. Cl. G06Q 50/06; G06Q 30/018

(52) U.S. Cl. CPC G06Q 50/06; G06Q 30/018

(57) ABSTRACT

A method for creating a user interface for state water regulations is provided. The method includes scraping a server hosting a state water regulatory website for sampling data for each of a plurality of compliance requirements for a particular public water system. For each of the plurality of compliance requirements, the method includes comparing the sampling data for the respective compliance requirement with sampling criteria associated defined under the respective compliance requirement and determining a time-to-sample value for the respective compliance requirement. The method includes generating a sorted sampling list for the particular public water system comprising a plurality of entries, each entry comprising an indication of a different compliance requirement and the time-to-sample value for the respective compliance requirement. The method includes outputting, for output via a display device, at least a portion of the sorted sampling list in a graphical user interface.

### RELATED APPLICATIONS

This application claims the benefit of U.S. Provisional Application No. 63/509,309, filed Jun. 21, 2023, the entire contents of which are incorporated herein by reference.

### TECHNICAL FIELD

The disclosure relates to a system for generating an improved user interface for water testing compliance.

### BACKGROUND OF THE INVENTION

Water utilities in the United States (and around the world) are subject to various regulations that ensure safe drinking water for their customers. In the USA, the passage of the Safe Drinking Water Act established what is called the National Primary Drinking Water Standards (NPDWR) which sets legally enforceable maximum contaminant levels (MCLs) for over 90 different chemical and biological substances. The laws also set forth what is called a “standard monitoring framework” (SMF)—a set of rules that determines what, when, where, and how often a water utility must take samples in order to prove to the public that their water is “safe”.

In reality, the set of rules governing what, when, where, and how often the utility must take samples are quite complex. For example, a utility may have to sample for Disinfection Byproducts (DBPs) every quarter, but the sample must be taken during a specific week in that quarter. Some samples must be taken multiple times a day. Other samples only have to be taken once every 9 years. For this reason, almost half of water quality violations received in the United States are actually due to either a “Failure to Collect” (e.g., when a water utility fails to collect a required sample), or “Failure to Report” (e.g., when the sample was not reported correctly to the regulatory agency by the due date). Currently, other than manually checking the website, there is no way for a water utility to know if they have taken all the samples they need to take and that the appropriate regulatory agency has received all their sampling results.

### SUMMARY OF THE INVENTION

In general, the disclosure describes a method for producing an improved graphical user interface for analyzing water sampling results. The method includes scraping, by one or more processors, a server hosting a state water regulatory website for sampling data for each of a plurality of compliance requirements for a particular public water system. The method further includes, for each of the plurality of compliance requirements, comparing, by the one or more processors, the sampling data for the respective compliance requirement with sampling criteria associated defined under the respective compliance requirement, and determining, by the one or more processors, a time-to-sample value for the respective compliance requirement. The method also includes generating, by the one or more processors, a sorted sampling list for the particular public water system, the sorted sampling list comprising a plurality of entries, each entry comprising at least an indication of a different compliance requirement of the plurality of compliance requirements and the time-to-sample value for the respective compliance requirement, wherein the entries in the sorted sampling list are sorted by the time-to-sample values. The method further includes outputting, by the one or more processors, and for output via a display device, at least a portion of the sorted sampling list in a graphical user interface.

The disclosure describes an algorithm that takes publicly available data on sampling requirements and compares that data to results posted on the State Regulatory Website. For each sampling requirement, the algorithm looks at the results. If there are sampling results that satisfy the requirement for the monitoring period in question, the algorithm may return a “validated” result. If there are no or not enough samples to satisfy the given requirement, the algorithm may return an “unvalidated” result. For unvalidated results, a number of days past due, or a number of days until the test is due, may be utilized to sort the list of results. In doing so, the graphical user interface enables a user to quickly ascertain which tests are of the highest priority to complete to ensure that the particular public water system is in compliance with state regulations. This reduces the input for having to navigate to different web pages and submitting multiple forms to gather each test individually, thereby reducing the amount of user input required to traverse the state regulatory website, reducing the amount of user input required to review results, reducing traffic that must be sent over a network to view these results, and overall improving the environment in which computing devices operate to gather this information. Furthermore, by generating a single list with highlights of which tests must be completed in a timely manner, the techniques described herein generate improved user interfaces to help agencies be in greater compliance with government regulations and laws.

In one example, the disclosure is directed to a method that includes scraping, by one or more processors, a server hosting a state water regulatory website for sampling data for each of a plurality of compliance requirements for a particular public water system. The method further includes, for each of the plurality of compliance requirements, comparing, by the one or more processors, the sampling data for the respective compliance requirement with sampling criteria associated defined under the respective compliance requirement and determining, by the one or more processors, a time-to-sample value for the respective compliance requirement. The method also includes generating, by the one or more processors, a sorted sampling list for the particular public water system, the sorted sampling list comprising a plurality of entries, each entry comprising at least an indication of a different compliance requirement of the plurality of compliance requirements and the time-to-sample value for the respective compliance requirement, wherein the entries in the sorted sampling list are sorted by the time-to-sample values. The method further includes outputting, by the one or more processors, and for output via a display device, at least a portion of the sorted sampling list in a graphical user interface.

In another example, the disclosure is directed to a computing device comprising one or more processors configured to scrape a server hosting a state water regulatory website for sampling data for each of a plurality of compliance requirements for a particular public water system. The one or more processors are further configured to, for each of the plurality of compliance requirements, compare the sampling data for the respective compliance requirement with sampling criteria associated defined under the respective compliance requirement and determine a time-to-sample value for the respective compliance requirement. The one or more processors are also configured to generate a sorted sampling list for the particular public water system, the sorted sampling list comprising a plurality of entries, each entry comprising at least an indication of a different compliance requirement of the plurality of compliance requirements and the time-to-sample value for the respective compliance requirement, wherein the entries in the sorted sampling list are sorted by the time-to-sample values. The one or more processors are further configured to output, for output via a display device, at least a portion of the sorted sampling list in a graphical user interface.

In another example, the disclosure is directed to a non-transitory computer-readable storage medium containing instructions. The instructions, when executed, cause one or more processors to perform scrape a server hosting a state water regulatory website for sampling data for each of a plurality of compliance requirements for a particular public water system. The instructions, when executed, further cause the one or more processors to, for each of the plurality of compliance requirements, compare the sampling data for the respective compliance requirement with sampling criteria associated defined under the respective compliance requirement and determine a time-to-sample value for the respective compliance requirement. The instructions, when executed, also cause the one or more processors to generate a sorted sampling list for the particular public water system, the sorted sampling list comprising a plurality of entries, each entry comprising at least an indication of a different compliance requirement of the plurality of compliance requirements and the time-to-sample value for the respective compliance requirement, wherein the entries in the sorted sampling list are sorted by the time-to-sample values. The instructions, when executed, further cause the one or more processors to output, for output via a display device, at least a portion of the sorted sampling list in a graphical user interface.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present disclosure and therefore do not limit the scope of the invention. The drawings are not necessarily to scale, though examples can include the scale illustrated, and are intended for use in conjunction with the explanations in the following detailed description wherein like reference characters denote like elements. Examples of the present disclosure will hereinafter be described in conjunction with the appended drawings.

FIG. 1 is a block diagram illustrating an example system for producing a sorted sampling list, in accordance with the techniques described herein.

FIG. 2 is a block diagram illustrating a more detailed example of a computing device configured to perform the techniques described herein.

FIG. 3 is a flow diagram illustrating an example method for generating and outputting a sorted sampling list, in accordance with the techniques described herein.

### DETAILED DESCRIPTION

The following detailed description is exemplary in nature and is not intended to limit the scope, applicability, or configuration of the techniques or systems described herein in any way. Rather, the following description provides some practical illustrations for implementing examples of the techniques or systems described herein. Those skilled in the art will recognize that many of the noted examples have a variety of suitable alternatives.

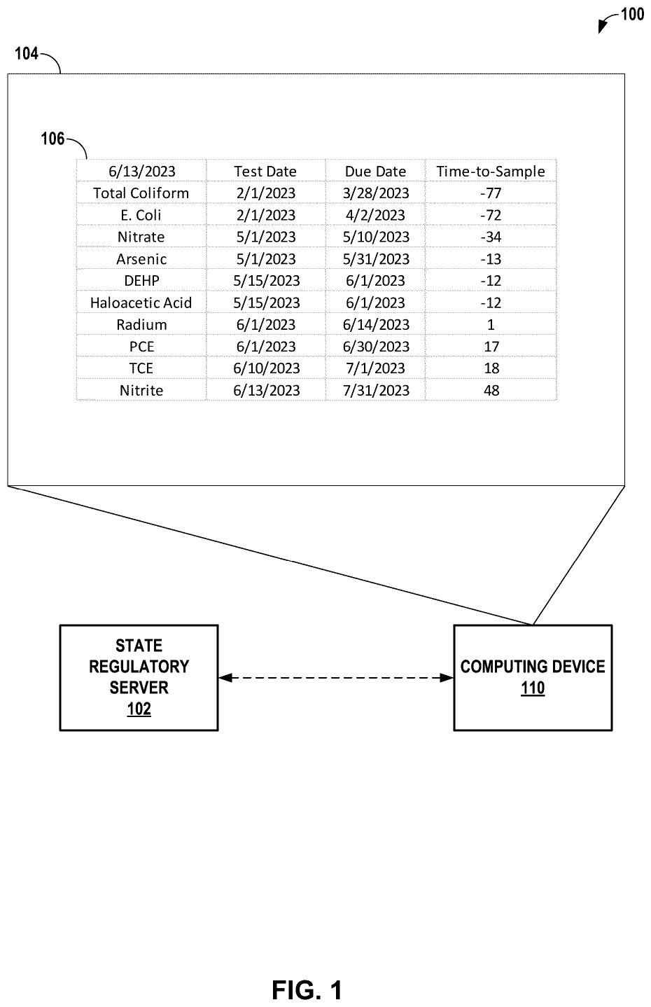

FIG. 1 is a block diagram illustrating an example system 100 for producing a sorted sampling list 106, in accordance with the techniques described herein. In the example of system 100, state regulatory server (SRS) 102 and computing device 110 are in communication, and computing device 110 may generate graphical user interface 104.

SRS 102 may be any computer with the processing power required to adequately execute the techniques described herein. For instance, SRS 102 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein. SRS 102 may store, either locally or remotely, data associated with water sampling tests and compliance requirements for particular public water systems to be tested within the jurisdiction, the jurisdiction being either at a city level, a state level, a territory level, or a country territory.

Computing device 110 may be any computer with the processing power required to adequately execute the techniques described herein. For instance, computing device 110 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

Computing device 110 may communicate with SRS 102. For instance, computing device 110 may receive user input to run a report for a particular public water system. Computing device 110 may automatically scrape SRS 102 to gather various testing data for the particular public water system. SRS 102 may store this data in a database, either locally or remotely. Rather than navigate the website hosted by SRS 102 to gather the various sampling data, computing device 110 may be granted access to the database itself from SRS 102 using secure protocols granted to the application or module performing the scraping. In other instances, computing device 110 may automatically cycle through each of a plurality of compliance requirements and individually retrieve the data through the website interface and graphical/text processing.

When computing device 110 retrieves this data, computing device 110 may generate sorted sampling list 106. Each element in sorted sampling list 106 may include a chemical or organism that is being tested for (e.g., “Total Coliform”), a most recent test date for that chemical or organism (e.g., Feb. 1, 2023), an earliest date for a test that has not yet been satisfied, or a deadline date for conducting a next test for that chemical or organism (e.g., Mar. 28, 2023), and a time-to-sample value, which can be calculated as a number of days between the current date (in the example of FIG. 1, the report was run on Jun. 13, 2023) and the earliest date for a test that has not yet been satisfied. For instance, with “E. coli”, the most recent test date for this particular public water system was performed on Feb. 1, 2023. However, another test came due on Apr. 2, 2023. As such, the time-to-sample may be calculated as −72, meaning that this test is 72 days overdue to be performed.

In another entry, a test for “Nitrite” on Jun. 13, 2023, the same day the report was run. Given this test, the next test for “Nitrite” is due on Jul. 31, 2023, which is 48 days from the date the report was run. This means a tester has 48 days to gather the proper sample before a jurisdiction's regulations are violated.

By sorting sorted sampling list 106 in this way, a user is able to quickly ascertain which samples must be taken to comply with a jurisdiction's regulations, and which order those samples could be taken in. In some instances, a status may also be provided, being indicated by a color code. For instance, all past due samples may be a shade of red, all samples with imminent due dates may be a shade of yellow, and all samples where no due date is imminent may be a shade of green, although other schemes and gradients may be utilized.

Computing device 110 may generate graphical user interface 104 to include sorted sampling list 106. Computing device 110 may output graphical user interface 104 for display, either locally on a display device incorporated into computing device 110 or physically connected to computing device 110, or remotely via wireless transmission.

The disclosure describes an algorithm that takes publicly available data on sampling requirements and compares that data to results posted on the State Regulatory Website. For each sampling requirement, the algorithm looks at the results. If there are sampling results that satisfy the requirement for the monitoring period in question, the algorithm may return a “validated” result. If there are no or not enough samples to satisfy the given requirement, the algorithm may return an “unvalidated” result. For unvalidated results, a number of days past due, or a number of days until the test is due, may be utilized to sort the list of results. In doing so, the graphical user interface enables a user to quickly ascertain which tests are of the highest priority to complete to ensure that the particular public water system is in compliance with state regulations. This reduces the input for having to navigate to different web pages and submitting multiple forms to gather each test individually, thereby reducing the amount of user input required to traverse the state regulatory website, reducing the amount of user input required to review results, reducing traffic that must be sent over a network to view these results, and overall improving the environment in which computing devices operate to gather this information. Furthermore, by generating a single list with highlights of which tests must be completed in a timely manner, the techniques described herein generate improved user interfaces to help agencies be in greater compliance with government regulations and laws.

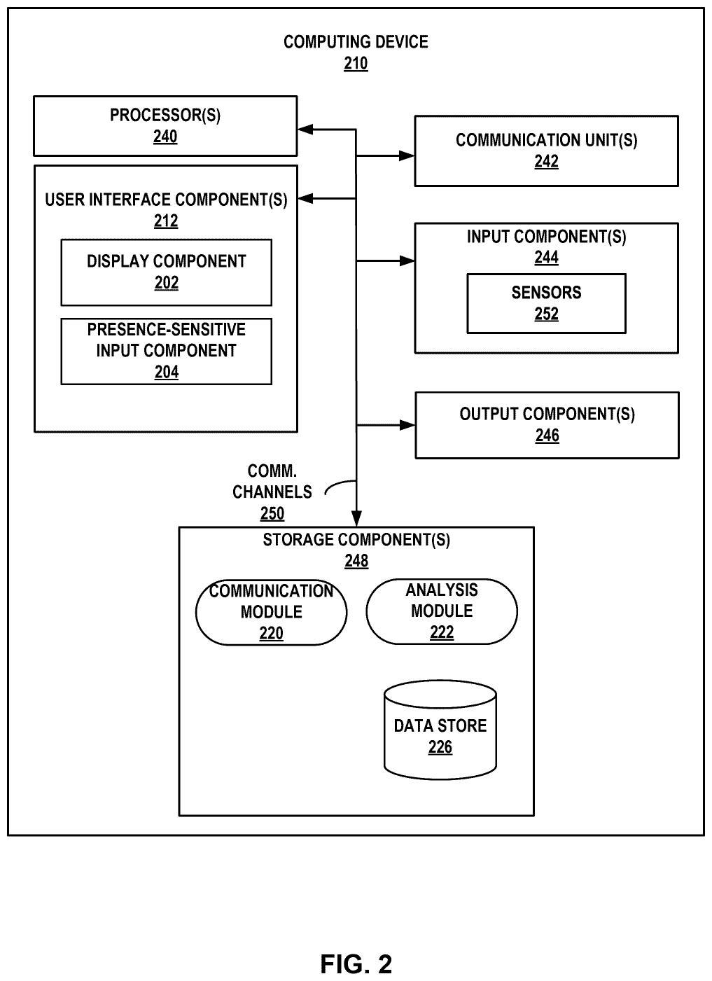

FIG. 2 is a block diagram illustrating a more detailed example of a computing device configured to perform the techniques described herein. Computing device 210 of FIG. 2 is described below as an example of computing device 110 of FIG. 1. FIG. 2 illustrates only one particular example of computing device 210, and many other examples of computing device 210 may be used in other instances and may include a subset of the components included in example computing device 210 or may include additional components not shown in FIG. 2.

Computing device 210 may be any computer with the processing power required to adequately execute the techniques described herein. For instance, computing device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in the example of FIG. 2, computing device 210 includes user interface components (UIC) 212, one or more processors 240, one or more communication units 242, one or more input components 244, one or more output components 246, and one or more storage components 248. UIC 212 includes display component 202 and presence-sensitive input component 204. Storage components 248 of computing device 210 include communication module 220, analysis module 222, and data store 226.

One or more processors 240 may implement functionality and/or execute instructions associated with computing device 210 to scrape state regulatory systems for water data. That is, processors 240 may implement functionality and/or execute instructions associated with computing device 210 to gather data from the state regulatory systems and produce a sorted sampling list.

Examples of processors 240 include any combination of application processors, display controllers, auxiliary processors, one or more sensor hubs, and any other hardware configured to function as a processor, a processing unit, or a processing device, including dedicated graphical processing units (GPUs). Modules 220 and 222 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222. The instructions, when executed by processors 240, may cause computing device 210 to gather data from the state regulatory systems and produce a sorted sampling list.

Communication module 220 may execute locally (e.g., at processors 240) to provide functions associated with managing communications between computing device 210 and outside servers or outside display devices. In some examples, communication module 220 may act as an interface to a remote service accessible to computing device 210. For example, communication module 220 may be an interface or application programming interface (API) to a remote server that scrapes state regulatory websites and data.

In some examples, analysis module 222 may execute locally (e.g., at processors 240) to provide functions associated with creating the sorted sampling list. In some examples, analysis module 222 may act as an interface to a remote service accessible to computing device 210. For example, analysis module 222 may be an interface or application programming interface (API) to a remote server that analyzes the data scraped from the state regulatory websites to produce the sorted sampling list.

One or more storage components 248 within computing device 210 may store information for processing during operation of computing device 210 (e.g., computing device 210 may store data accessed by modules 220 and 222 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222 and data store 226. Storage components 248 may include a memory configured to store data or other information associated with modules 220 and 222 and data store 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g., such as an Ethernet card), an optical transceiver, a radio frequency transceiver, a GPS receiver, a radio-frequency identification (RFID) transceiver, a near-field communication (NFC) transceiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, include a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras), one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a radar sensor, a lidar sensor, a sonar sensor, a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, include a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UIC 212 of computing device 210 may include display component 202 and presence-sensitive input component 204. Display component 202 may be a screen, such as any of the displays or systems described with respect to output components 246, at which information (e.g., a visual indication) is displayed by UIC 212 while presence-sensitive input component 204 may detect an object at and/or near display component 202.

While illustrated as an internal component of computing device 210, UIC 212 may also represent an external component that shares a data path with computing device 210 for transmitting and/or receiving input and output. For instance, in one example, UIC 212 represents a built-in component of computing device 210 located within and physically connected to the external packaging of computing device 210 (e.g., a screen on a mobile phone). In another example, UIC 212 represents an external component of computing device 210 located outside and physically separated from the packaging or housing of computing device 210 (e.g., a monitor, a projector, etc. that shares a wired and/or wireless data path with computing device 210).

UIC 212 of computing device 210 may detect two-dimensional and/or three-dimensional gestures as input from a user of computing device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

In accordance with the techniques of this disclosure, communication module 220 may scrape a server hosting a state water regulatory website for sampling data for each of a plurality of compliance requirements for a particular public water system. In some instances, the sampling data may be any one or more of a type of test conducted (e.g., which compound or organism being tested for, or which compliance requirement is being tested), a date of a most recent test, a time span of a most recent sequence of tests, a pass/fail indication of a most recent test, an amount of water tested, and a location within the particular public water system tested.

For each of the plurality of compliance requirements, analysis module 222 may compare the sampling data for the respective compliance requirement with sampling criteria associated defined under the respective compliance requirement. The sampling criteria may include any one or more of a testing frequency for the compliance requirement, a test procedure for the compliance requirement, a location to be tested for the compliance requirement, a component to be tested, pass/fail criteria, and a due date for the compliance requirement. Analysis module may also determine a time-to-sample value for the respective compliance requirement. The time-to-sample value may be a number of days until a next due date for the compliance requirement based on a date of the most recent test recorded in the sampling data for the compliance requirement and the sampling criteria of the compliance requirement. For instance, the time-to-sample value may be a negative value when the sampling data indicates that the respective compliance requirement is past due.

Analysis module 222 may generate a sorted sampling list for the particular public water system, the sorted sampling list comprising a plurality of entries, each entry including at least an indication of a different compliance requirement of the plurality of compliance requirements and the time-to-sample value for the respective compliance requirement, wherein the entries in the sorted sampling list are sorted by the time-to-sample values. In some instances, the sorted sampling list is sorted by the time-to-sample values in ascending order.

Communication module 220 may output, for output via a display device (e.g., UIC 212), at least a portion of the sorted sampling list in a graphical user interface.

In some instances, for each of the plurality of compliance requirements, based on the comparing of the sampling data with the sampling criteria, analysis module 222 may further determine a status for the respective compliance requirement. Analysis module 222 may also color-code each entry of the plurality of entries based on the status for the respective compliance requirement. The status may be any one or more of past due, sampling due within a first predetermined time period, sampling due within a second predetermined time period, and sampling not due within a third predetermined time period.

In some instances, analysis module 222 may determine, based on the plurality of compliance requirements and the sampling data for each respective compliance requirement, whether the particular public water system is in compliance with state regulations. In some instances, analysis module 222 may generate the graphical user interface to further include an indication of whether the particular public water system is in compliance with the state/jurisdiction regulations.

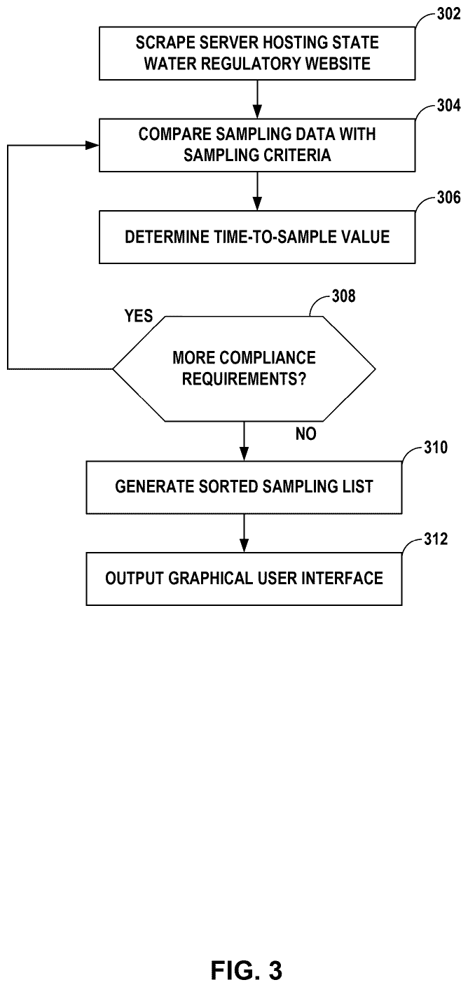

FIG. 3 is a flow chart illustrating an example mode of operation. The techniques of FIG. 3 may be performed by one or more processors of a computing device, such as system 100 of FIG. 1 and/or computing device 210 illustrated in FIG. 2. For purposes of illustration only, the techniques of FIG. 3 are described within the context of computing device 210 of FIG. 2, although computing devices having configurations different than that of computing device 210 may perform the techniques of FIG. 3.

In accordance with the techniques described herein, communication module 220 may scrape a server hosting a state water regulatory website for sampling data for each of a plurality of compliance requirements for a particular public water system (302). For each of the plurality of compliance requirements, analysis module 222 may compare the sampling data for the respective compliance requirement with sampling criteria associated defined under the respective compliance requirement (304) and determine a time-to-sample value for the respective compliance requirement (306). If there are more compliance requirements to analyze (“YES” branch of 308), analysis module 222 repeats steps 304 and 306. If analysis module 222 has completed the analysis of the compliance requirements and sampling data (“NO” branch of 308), analysis module 222 may generate a sorted sampling list for the particular public water system, the sorted sampling list comprising a plurality of entries (310). Each entry may include at least an indication of a different compliance requirement of the plurality of compliance requirements and the time-to-sample value for the respective compliance requirement, wherein the entries in the sorted sampling list are sorted by the time-to-sample values. Communication module 220 may output, for output via a display device, at least a portion of the sorted sampling list in a graphical user interface (312).

Example 1. A method comprising: scraping, by one or more processors, a server hosting a state water regulatory website for sampling data for each of a plurality of compliance requirements for a particular public water system; for each of the plurality of compliance requirements: comparing, by the one or more processors, the sampling data for the respective compliance requirement with sampling criteria associated defined under the respective compliance requirement; and determining, by the one or more processors, a time-to-sample value for the respective compliance requirement; generating, by the one or more processors, a sorted sampling list for the particular public water system, the sorted sampling list comprising a plurality of entries, each entry comprising at least an indication of a different compliance requirement of the plurality of compliance requirements and the time-to-sample value for the respective compliance requirement, wherein the entries in the sorted sampling list are sorted by the time-to-sample values; and outputting, by the one or more processors, and for output via a display device, at least a portion of the sorted sampling list in a graphical user interface.

Example 2. The method of example 1, further comprising: for each of the plurality of compliance requirements, based on the comparing of the sampling data with the sampling criteria, determining, by the one or more processors, a status for the respective compliance requirement.

Example 3. The method of example 2, further comprising: color-coding, by the one or more processors, each entry of the plurality of entries based on the status for the respective compliance requirement.

Example 4. The method of any one or more of examples 2-3, wherein the status comprises one or more of: past due; sampling due within a first predetermined time period; sampling due within a second predetermined time period; and sampling not due within a third predetermined time period.

Example 5. The method of any one or more of examples 1-4, wherein the sampling data comprises one or more of: a type of test conducted; a date of a most recent test; a time span of a most recent sequence of tests; a pass/fail indication of a most recent test; an amount of water tested; and a location within the particular public water system tested.

Example 6. The method of any one or more of examples 1-5, wherein the sampling criteria comprises one or more of: a testing frequency for the compliance requirement; a test procedure for the compliance requirement; a location to be tested for the compliance requirement; a component to be tested; pass/fail criteria; and a due date for the compliance requirement.

Example 7. The method of any one or more of examples 1-6, wherein the time-to-sample value comprises a number of days until a next due date for the compliance requirement based on a date of the most recent test recorded in the sampling data for the compliance requirement and the sampling criteria of the compliance requirement.

Example 8. The method of example 7, wherein the time-to-sample value comprises a negative value when the sampling data indicates that the respective compliance requirement is past due.

Example 9. The method of any one or more of examples 7-8, wherein the sorted sampling list is sorted by the time-to-sample values in ascending order.

Example 10. The method of any one or more of examples 1-9, further comprising: determining, based on the plurality of compliance requirements and the sampling data for each respective compliance requirement, whether the particular public water system is in compliance with state regulations.

Example 11. The method of example 10, wherein graphical user interface further includes an indication of whether the particular public water system is in compliance with the state regulations.

Example 12. A method for performing any of the techniques of any combination of examples 1-11.

Example 13. A device configured to perform any of the methods of any combination of examples 1-11.

Example 14. An apparatus comprising means for performing any of the method of any combination of examples 1-11.

Example 15. A non-transitory computer-readable storage medium having stored thereon instructions that, when executed, cause one or more processors of a computing device to perform the method of any combination of examples 1-11.

Example 16. A system comprising one or more computing devices configured to perform a method of any combination of examples 1-11.

Example 17. Any of the techniques described herein.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount—including any integer—between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure.

Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range. Although the various embodiments have been described with reference to preferred implementations, persons skilled in the art will recognize that changes may be made in form and detail without departing from the spirit and scope thereof.

Various examples of the disclosure have been described. Any combination of the described systems, operations, or functions is contemplated. These and other examples are within the scope of the following claims.

1. A method comprising:
scraping, by one or more processors, a server hosting a state water regulatory website for sampling data for each of a plurality of compliance requirements for a particular public water system;
for each of the plurality of compliance requirements:
comparing, by the one or more processors, the sampling data for the respective compliance requirement with sampling criteria associated defined under the respective compliance requirement; and
determining, by the one or more processors, a time-to-sample value for the respective compliance requirement;
generating, by the one or more processors, a sorted sampling list for the particular public water system, the sorted sampling list comprising a plurality of entries, each entry comprising at least an indication of a different compliance requirement of the plurality of compliance requirements and the time-to-sample value for the respective compliance requirement, wherein the entries in the sorted sampling list are sorted by the time-to-sample values; and
outputting, by the one or more processors, and for output via a display device, at least a portion of the sorted sampling list in a graphical user interface.

2. The method of claim 1, further comprising:
for each of the plurality of compliance requirements, based on the comparing of the sampling data with the sampling criteria, determining, by the one or more processors, a status for the respective compliance requirement.

3. The method of claim 2, further comprising:
color-coding, by the one or more processors, each entry of the plurality of entries based on the status for the respective compliance requirement.

4. The method of claim 2, wherein the status comprises one or more of:
past due;
sampling due within a first predetermined time period;
sampling due within a second predetermined time period; and
sampling not due within a third predetermined time period.

5. The method of claim 1, wherein the sampling data comprises one or more of:
a type of test conducted;
a date of a most recent test;
a time span of a most recent sequence of tests;
a pass/fail indication of a most recent test;
an amount of water tested; and
a location within the particular public water system tested.

6. The method of claim 1, wherein the sampling criteria comprises one or more of:
a testing frequency for the compliance requirement;
a test procedure for the compliance requirement;
a location to be tested for the compliance requirement;
a component to be tested;
pass/fail criteria; and
a due date for the compliance requirement.

7. The method of claim 1, wherein the time-to-sample value comprises a number of days until a next due date for the compliance requirement based on a date of the most recent test recorded in the sampling data for the compliance requirement and the sampling criteria of the compliance requirement.

8. The method of claim 7, wherein the time-to-sample value comprises a negative value when the sampling data indicates that the respective compliance requirement is past due.

9. The method of claim 7, wherein the sorted sampling list is sorted by the time-to-sample values in ascending order.

10. The method of claim 1, further comprising:
determining, by the one or more processors, based on the plurality of compliance requirements and the sampling data for each respective compliance requirement, whether the particular public water system is in compliance with state regulations.

11. The method of claim 10, wherein the graphical user interface further includes an indication of whether the particular public water system is in compliance with the state regulations.

12. A computing device comprising one or more processors configured to:
scrape a server hosting a state water regulatory website for sampling data for each of a plurality of compliance requirements for a particular public water system;
for each of the plurality of compliance requirements:
compare the sampling data for the respective compliance requirement with sampling criteria associated defined under the respective compliance requirement; and
determine a time-to-sample value for the respective compliance requirement;
generate a sorted sampling list for the particular public water system, the sorted sampling list comprising a plurality of entries, each entry comprising at least an indication of a different compliance requirement of the plurality of compliance requirements and the time-to-sample value for the respective compliance requirement, wherein the entries in the sorted sampling list are sorted by the time-to-sample values; and
output, for output via a display device, at least a portion of the sorted sampling list in a graphical user interface.

13. The computing device of claim 12, wherein the one or more processors are further configured to:
for each of the plurality of compliance requirements, based on the comparing of the sampling data with the sampling criteria, determine a status for the respective compliance requirement.

14. The computing device of claim 12, wherein the sampling data comprises one or more of:
a type of test conducted;
a date of a most recent test;
a time span of a most recent sequence of tests;
a pass/fail indication of a most recent test;
an amount of water tested; and
a location within the particular public water system tested.

15. The computing device of claim 12, wherein the time-to-sample value comprises a number of days until a next due date for the compliance requirement based on a date of the most recent test recorded in the sampling data for the compliance requirement and the sampling criteria of the compliance requirement.

16. The computing device of claim 12, wherein the one or more processors are further configured to:
determine, based on the plurality of compliance requirements and the sampling data for each respective compliance requirement, whether the particular public water system is in compliance with state regulations.

17. A non-transitory computer-readable storage medium having stored thereon instructions that, when executed, cause one or more processors of a computing device to:
scrape a server hosting a state water regulatory website for sampling data for each of a plurality of compliance requirements for a particular public water system;
for each of the plurality of compliance requirements:
compare the sampling data for the respective compliance requirement with sampling criteria associated defined under the respective compliance requirement; and
determine a time-to-sample value for the respective compliance requirement;
generate a sorted sampling list for the particular public water system, the sorted sampling list comprising a plurality of entries, each entry comprising at least an indication of a different compliance requirement of the plurality of compliance requirements and the time-to-sample value for the respective compliance requirement, wherein the entries in the sorted sampling list are sorted by the time-to-sample values; and
output, for output via a display device, at least a portion of the sorted sampling list in a graphical user interface.

18. The non-transitory computer-readable storage medium of claim 17, wherein the instructions further cause the one or more processors to:
for each of the plurality of compliance requirements, based on the comparing of the sampling data with the sampling criteria, determine a status for the respective compliance requirement.

19. The non-transitory computer-readable storage medium of claim 17, wherein the time-to-sample value comprises a number of days until a next due date for the compliance requirement based on a date of the most recent test recorded in the sampling data for the compliance requirement and the sampling criteria of the compliance requirement.

20. The non-transitory computer-readable storage medium of claim 17, wherein the instructions further cause the one or more processors to:
determine, based on the plurality of compliance requirements and the sampling data for each respective compliance requirement, whether the particular public water system is in compliance with state regulations.
